(19) United States
(12) Patent Application Publication
(10) Pub. No.: US 2011/0031822 A1
(43) Pub. Date: Feb. 10, 2011

(54) VOICE COIL MOTOR FOR DRIVING LENS

(75) Inventor: TAI-HSU CHOU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/750,715

(22) Filed: Mar. 31, 2010

(30) Foreign Application Priority Data
Aug. 6, 2009 (CN) 200910305302.9

(51) Int. Cl. H02K 41/035

(52) U.S. Cl. 310/12.16

(57) ABSTRACT

Voice coil motor includes a housing shell, a fixing member, a movable member and elastic members. The fixing member includes a bracket and a number of first magnetic members retained on the bracket. The movable member includes a retainer and a number of second magnetic members mounted thereon. One of the first or the second magnetic member includes a first permanent magnet and a second permanent magnet abutting against the first permanent magnet, with each of the first and second permanent magnets including an N polarity side and an S polarity side. A pair of the first and second permanent magnets facing the same other one of the first and second magnetic members with only the N polarity side of the first permanent magnet and only the S polarity side of the second permanent magnet facing the same the other one of the first and second magnetic member.

### BACKGROUND

1. Technical Field

The present disclosure relates to voice coil motors, and particularly, to a voice coil motor for driving a lens.

2. Description of Related Art

Voice coil motors are widely used as actuators for driving lenses in camera modules.

A typical voice coil motor includes a fixing member, a movable member, and a housing shell which houses the fixing member and the movable member therein. The fixing member has a number of permanent magnets mounted thereon, the movable member has a number of coils of wire mounted thereon, and one of the permanent magnets faces one of the coils of wire.

Generally, the magnetic field density is higher at the two ends of the permanent magnet, and the magnetic fields are more spread apart at the middle portion of the permanent magnets. Thus, the magnetic force is stronger at the ends. That is, the magnetic force provided in the middle portion becomes too weak.

What is needed, therefore, is a voice coil motor which can overcome the above shortcoming.

### BRIEF DESCRIPTION OF THE DRAWINGS

Many aspects of the present voice coil motor can be better understood with reference to the following drawings. The components in the drawings are not necessarily drawn to scale, the emphasis instead being placed upon clearly illustrating the principles of the present voice coil motor. Moreover, in the drawings, like reference numerals designate corresponding parts throughout the several views.

FIG. 1 is a schematic view of a voice coil motor in accordance with an embodiment.

FIG. 2 is an exploded view of the voice coil motor of FIG. 1.

FIG. 3 shows a position relationship among a first permanent magnet, a second permanent magnet, and a coil of wire, and the lines representing a magnetic field cooperatively formed by the first and second permanent magnets are also included.

### DETAILED DESCRIPTION

Embodiments of the present voice coil motor will now be described in detail below and with reference to the drawings.

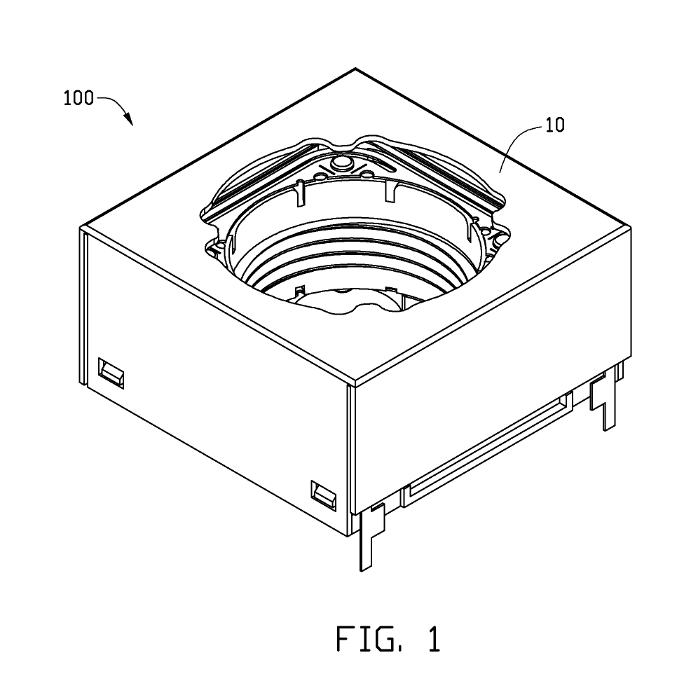

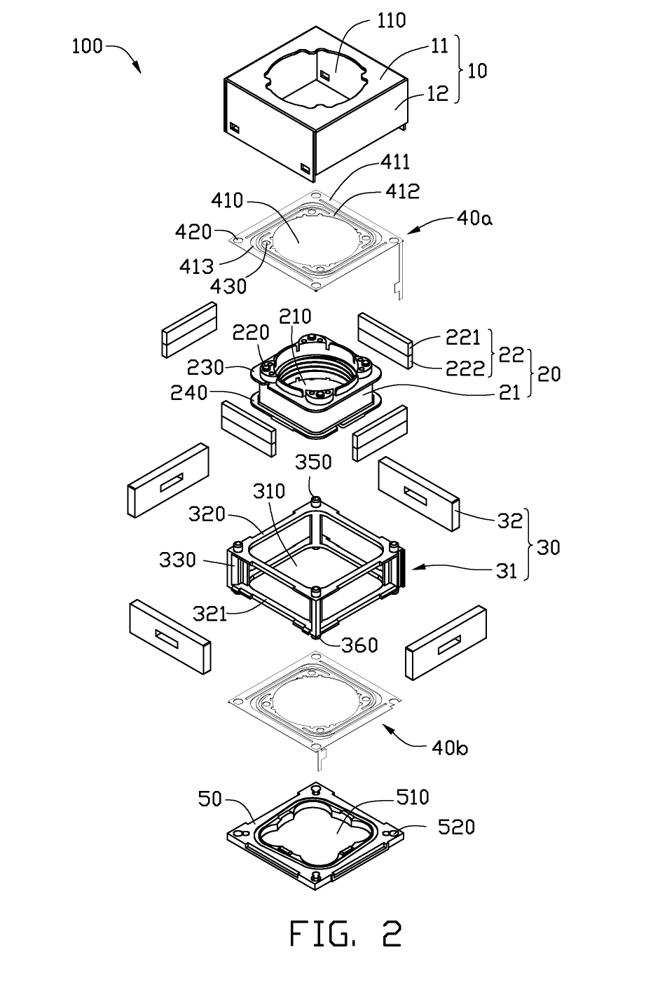

Referring to FIGS. 1 and 2, a voice coil motor 100 in accordance with an embodiment, is provided. The voice coil motor 100 includes a base 50, a shell 10, a fixing member 30, a movable member 20, a first elastic member 40a, and a second elastic member 40b.

The shell 10 is mounted on the base 50. The shell 10 and the base 50 cooperatively define a housing space or receiving space therein and two openings 110, 510 at the shell 10 and the base 50, respectively, in communication with the housing space or receiving space. The base 50 further includes four engaging holes 520 formed at four corners thereof. The shell 10 includes a top cover 11 and four side covers 12. The top cover 11, the side covers 12, and the base 50 cooperatively enclose the housing space. The housing space is configured for receiving the fixing member 30, movable member 20, first elastic member 40a and second elastic member 40b therein.

The fixing member 30 includes a square bracket 31 and a first magnetic member in the form of four coils of wire 32. The bracket 31 is made up of eight horizontal bars 320 and four vertical bars 330. The vertical bars 330 extend through the horizontal bars 320 and thus form four protrusions 350 on the top of the bracket 31 and four protrusions 360 on the bottom of the bracket 31. The horizontal bars 320 and the vertical bars 330 cooperatively define a through hole 310 therein and four side retaining spaces 321 in communication with the through hole 310. The coils of wire 32 (the first magnetic member) are retained in the side retaining spaces 321, respectively.

The movable member 20 is movably received in the through hole 310 of the bracket 31. The movable member 20 includes a retainer 21 and four magnetic members 22. The retainer 21 defines a through hole 210 therein, and includes a quadrate first tab 230 and a quadrate second tab 240 extending from a top surface and a bottom surface thereof, respectively. The retainer 21 further includes four protrusions 220 extending from a top thereof, and four protrusions (not labeled) extending from a bottom thereof. The magnetic members 22 are mounted on an outer wall of the retainer 21, and sandwiched between the first and second tabs 230, 240.

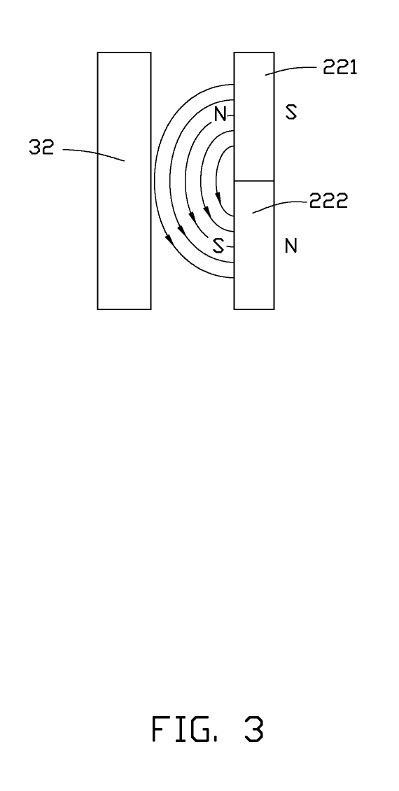

Each of the magnetic members 22 includes a first permanent magnet 221 and a second permanent magnet 222 abutting against the first permanent magnet 221. Referring also to FIG. 3, each of the first and second permanent magnets 221, 222 includes an N polarity side and an S polarity side. A pair of the first and second permanent magnets 221, 222 face a same one of the coils of wire 32 with only the N polarity side of the first permanent magnet 221 and only the S polarity side of the second permanent magnet 222 facing the same one of the coils of wire 32. The N polarity side of the first permanent magnet 221 and the S polarity side of the second permanent magnet 222 are able to provide a magnetic field (see the arrowed lines representing the magnetic field) for the coil of wire 32. As the N polarity side of the first permanent magnet 221 is in contact with the S polarity side of the second permanent magnet 222, the lines representing the magnetic field are uniformly distributed on the N polarity side of the first permanent magnet 221 and the S polarity side of the second permanent magnet 222, such that each of the magnetic members 22 provides a more uniform and stronger magnetic force for the respective coils of wire 32. In the reverse, each of the magnetic members 22 is applied on a more uniform and stronger magnetic force.

It is understood that the magnetic members 22 can be mounted to the bracket 31, and the coils of wire 32 can be mounted to the retainer 21, i.e., the positions of the magnetic members 22 and the coils of wire 32 can switch place with each other.

The first and second elastic members 40a, 40b are located on a top and a bottom of the fixing member 30 and the movable member 20, respectively, and are structured and arranged for connecting the movable member 20 to the fixing member 30. Each of the first and second elastic members 40a, 40b is square and includes a central elastic portion 412 attached to the retainer 21 and a peripheral portion 411 fixed to the bracket 31. A number of L-shaped cutouts 413 are located between the peripheral portion 411 and the central elastic portion 412 to provide elasticity for the central elastic portion 412. Each of the peripheral portions 411 includes four through holes 420 at four corners thereof, respectively. Each of the central elastic portions 412 includes four through holes 430 at four corners thereof, respectively.

The protrusions 350, 360 of the bracket 31 engage in and extend through the through holes 420 of the peripheral portions 411 of the first and second elastic members 40a, 40b, respectively, such that the first and second elastic members 40a, 40b are fixed to the bracket 31. The protrusions 360 are further engaged in the engaging holes 520 of the base 50. The protrusions 220 at the top of the retainer 21 and the protrusions 220 at the bottom of the retainer 21 engage in and extend through the through holes 430 of the central elastic portions 412 of the first and second elastic members 40a, 40b, such that the retainer 21 is attached to the central elastic portions 412 of the first and second elastic members 40a, 40b. The central elastic portions 412 of the first and second elastic members 40a, 40b provide elasticity for the retainer 21, thereby providing activity space for the retainer 21. The protrusions 220 and the through holes 430 ensure the movement direction does not deviate from a central axis of the retainer 21.

A lens or a lens group can be received in the through hole 210 of the retainer 21, such that the lens or the lens group can be driven.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A voice coil motor, comprising:
a base
a shell mounted on the base, the shell and the base cooperatively defining a receiving space therein;
a fixing member and a movable member received in the receiving space, the fixing member comprising a bracket defining a through hole therein and a plurality of side retaining spaces in communication with the through hole, and a plurality of coils of wire retained in the side retaining spaces, respectively, the movable member being movably received in the through hole of the bracket, and the movable member comprising a retainer and a plurality of magnetic members mounted on an outer wall of the retainer, each of the magnetic members comprising a first permanent magnet and a second permanent magnet abutting against the first permanent magnet, each of the first and second permanent magnets comprising an N polarity side and an S polarity side, a pair of the first and second permanent magnets facing a same one of the coils of wire with only the N polarity side of the first permanent magnet and only the S polarity side of the second permanent magnet facing the same one of the coils of wire; and
a first elastic member and a second elastic member connecting the movable member to the fixing member.

2. The voice coil motor as claimed in claim 1, wherein each of the base, the shell, the retainer, the first and second elastic members has a through hole defined therein.

3. The voice coil motor as claimed in claim 1, wherein the retainer comprises a first tab and a second tab extending from a top surface and a bottom surface thereof, respectively, and the magnetic members are sandwiched between the first and second tabs.

4. The voice coil motor as claimed in claim 1, wherein each of the first and second elastic members is square and comprises a central elastic portion attached to the retainer and a peripheral portion fixed to the bracket.

5. The voice coil motor as claimed in claim 4, wherein each of the peripheral portions comprises a plurality of through holes formed therein, each of the bracket comprises a plurality of protrusions at the top and the bottom of the bracket, and the protrusions engage in and extend through the through holes of the peripheral portions, respectively.

6. The voice coil motor as claimed in claim 5, wherein the base comprises a plurality of engaging holes formed therein, and the protrusions at the bottom of the bracket are further engaged in the engaging holes.

7. The voice coil motor as claimed in claim 4, wherein each of the central elastic portions comprises a plurality of through holes formed therein, each of the retainer comprises a plurality of protrusions at the top and the bottom of the retainer, and the protrusions engage in and extend through the through holes of the central elastic portions.

8. The voice coil motor as claimed in claim 4, wherein a plurality of L-shaped cutouts is located between the peripheral portion and the central elastic portion.

9. A voice coil motor for driving lens, comprising:
a housing shell defining a housing space therein and two openings at two ends thereof in communication with the housing space;
a fixing member fixed in the housing space, the fixing member comprising a bracket defining a through hole therein and a plurality of side retaining spaces in communication with the through hole, and a plurality of coils of wire retained in the side retaining spaces, respectively;
a movable member movably received in the through hole of the bracket, the movable member comprising a retainer defining a space for receiving the lens, and a plurality of magnetic members mounted on an outer wall of the retainer, each of the magnetic members comprising a first permanent magnet and a second permanent magnet abutting against the first permanent magnet, each of the first and second permanent magnets comprising an N polarity side and an S polarity side, a pair of the first and second permanent magnets facing a same one of the coils of wire with only the N polarity side of the first permanent magnet and only the S polarity side of the second permanent magnet facing the same one of the coils of wire; and
a plurality of elastic members connecting the retainer to the bracket.

10. The voice coil motor as claimed in claim 9, wherein the retainer comprises a first tab and a second tab extending from a top surface and a bottom surface thereof, respectively, and the magnetic members are sandwiched between the first and second tabs.

11. The voice coil motor as claimed in claim 9, wherein each of the first and second elastic members is square and comprises a central elastic portion attached to the retainer and a peripheral portion fixed to the bracket.

12. The voice coil motor as claimed in claim 11, wherein each of the peripheral portions comprises a plurality of through holes formed therein, each of the bracket comprises a plurality of protrusions at the top and the bottom of the bracket, and the protrusions engage in and extend through the through holes of the peripheral portions, respectively.

13. The voice coil motor as claimed in claim 11, wherein each of the central elastic portions comprises a plurality of through holes formed therein, each of the retainer comprises a plurality of protrusions at the top and the bottom of the retainer, and the protrusions engage in and extend through the through holes of the central elastic portions.

14. The voice coil motor as claimed in claim 11, wherein a plurality of L-shaped cutouts is located between the peripheral portion and the central elastic portion.

15. A voice coil motor, comprising:
a housing shell defining a housing space therein;
a fixing member and a movable member received in the housing space, the fixing member comprising a bracket defining a through hole therein and a plurality of side retaining spaces in communication with the through hole, and a plurality of first magnetic members retained in the side retaining spaces, respectively, the movable member being movably received in the through hole of the bracket, and the movable member comprising a retainer and a plurality of second magnetic members mounted on an outer wall of the retainer, one of the first or the second magnetic member comprising a first permanent magnet and a second permanent magnet abutting against the first permanent magnet, each of the first and second permanent magnets comprising an N polarity side and an S polarity side, a pair of the first and second permanent magnets facing the same other one of the first and the second magnetic members with only the N polarity side of the first permanent magnet and only the S polarity side of the second permanent magnet facing the same other one of the first and the second magnetic members; and
a plurality of elastic members connecting the retainer to the bracket.
